(19) United States
(12) Patent Application Publication
(10) Pub. No.: US 2011/0267303 A1
(43) Pub. Date: Nov. 3, 2011

(54) CAPACITIVE TOUCH PANEL

(75) Inventors: JIAN-TING CHEN, CHANGHUA COUNTY (TW); CHANG-PO CHAO, Banqiao City (TW); JYUN-YAO RUAN, CHANGHUA COUNTY (TW)

(73) Assignee: ACER INCORPORATED, TAIPEI COUNTY (TW)

(21) Appl. No.: 12/770,712

(22) Filed: May 2, 2010

(51) Int. Cl. G06F 3/044

(52) U.S. Cl. 345/174

(57) ABSTRACT

The present invention discloses a capacitive touch panel comparing a first electrode layer, a dielectric layer and a second electrode layer. The first electrode layer has a first pattern. Also, the dielectric layer is disposed under the first electronic layer with a second pattern. Moreover, the first pattern and the second pattern are complementary.

### FIELD

The present invention relates to a field of capacitive touch panels. More specifically, the present invention relates to capacitive touch panels that comprise complementary upper and lower electrode patterns.

### BACKGROUND

Nowadays, conventional capacitive touch panels detect changes of the capacitance to sense human contact and are generally consisting of capacitor array and capacitor sensing-reading circuits. Besides, the capacitor array is the capacitor formed by the upper layer wire pattern and the lower layer wire pattern, and different capacitances are generated by different design patterns. Also, the upper layer and the lower layer of the conventional capacitive touch panels are usually designed by opposite pattern. However, though the upper and lower layer designed by opposite patterns increase the sensitivity of the vertical capacitive detecting, the planar capacitive detecting is worse. In addition, if the touch panel utilizes indium tin oxide (ITO) as wires, the resistance will increase in proportion to the panel size. Moreover, the opposite patterns of the upper and lower electrode are used for optimizing the sensitivity, so the sensitivity will decrease dramatically if the front side and reverse side of the touch panel are changed.

The US patent application US200710062739 discloses an electrode pattern adopted general dual layer design, and the upper and lower layers thereof are designed to have the same direction. Due to the structure thereof, the capacitance change can be measured only on a single surface and can not be detected while bending. Moreover, the capacitances interfere with each other so as to decrease the sensitivity of the detection. On the other hand, the US patent application 2007/0229470 only provides a method for bending the capacitive touch sensor; also, the sensitivity of the structure and design method thereof can not have the maximum efficiency and are not able to adjust the sensitivity of the touch panel by the bending levels.

“A Pixel-level Automatic Calibration Circuit Scheme,” presented by Morimura et al., discloses integrating the touch capacitive sensor on pixels to measure the fingerprint. The sensing circuit must be disposed under the capacitor and without the bending effect. On the other hand, “Method for Testing Electrostatic Discharge Tolerance for Fingerprint Sensor LSI,” presented by Yasuyuki et al., discloses a design and manufacture method that utilize touch control panel to identify fingerprint The design and manufacture method are lack of bending function and the sensitivity will be decreased.

### SUMMARY

Regarding to the drawbacks of the conventional capacitive touch panel, the object of the present invention is providing a capacitive touch panel that solves the shielding problem in the design of the conventional capacitive touch panel.

Another object of the present invention is providing a capacitive touch panel comprising a first electrode layer comprising a first pattern, a dielectric layer disposed under the first electrode layer, and a second electrode layer disposed under the dielectric layer and comprising a second pattern. Also, the second pattern and the first pattern are complementary.

Another object of the present invention is providing a capacitive touch panel comprising a first electrode layer comprising a first pattern, a dielectric layer disposed on the first electrode layer, and a second electrode layer disposed under the dielectric layer and comprising a second pattern. Besides, the second pattern and the first pattern are complementary.

According to the aforementioned description, the capacitive touch panel in accordance with the present invention has one or more advantages as following:

(1) The capacitive touch panel can detect the capacitive between rows, columns, and the capacitive between row and column by designing the electrode patterns. Thus, the drawbacks that conventional capacitive touch panel only detects the vertical capacitive can be eliminated.

(2) The capacitive touch panel can solve the problem that the upper and lower electrodes interferes each other by designing the electrode patterns.

(3) The capacitive touch panel is able to detect by planar capacitor, therefore, the detection can be made rapidly because of the planar capacitor.

(4) The capacitive touch panel can solve the power consumption problem of the product through controlling the capacitive touch panel adequately without sacrificing the touch detection functionality.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates the sectional view of a touch capacitive panel in accordance with the present invention;

FIG. 2 illustrates the schematic view of the first electrode layer in accordance with the present invention;

FIG. 3 illustrates the schematic view of the second electrode layer in accordance with the present invention;

FIG. 4 illustrates the schematic view of the first embodiment in accordance with the present invention;

FIGS. 5 illustrates the schematic view of the second embodiment in accordance with the present invention;

FIG. 6 illustrates the schematic view of the third embodiment in accordance with the present invention;

FIG. 7 illustrates the schematic view of the fourth embodiment in accordance with the present invention;

FIG. 8 illustrates the schematic view of the fifth embodiment in accordance with the present invention; and

FIG. 9 illustrates the schematic view of the sixth embodiment in accordance with the present invention.

### DETAILED DESCRIPTION

Exemplary embodiments of the present invention are described herein in the context of an orthodontic appliance. The invention and its various embodiments can now be better understood by turning to the following detailed description of the preferred embodiments. Those of ordinary skilled in the art will realize that the following detailed description of the exemplary embodiments is illustrative only and is not intended to be in any way limiting. Reference will now be made in detail to implementations of the exemplary embodiments as illustrated in the accompanying drawings. The same reference indicators will be used throughout the drawings and the following detailed description to refer to the same or like parts.

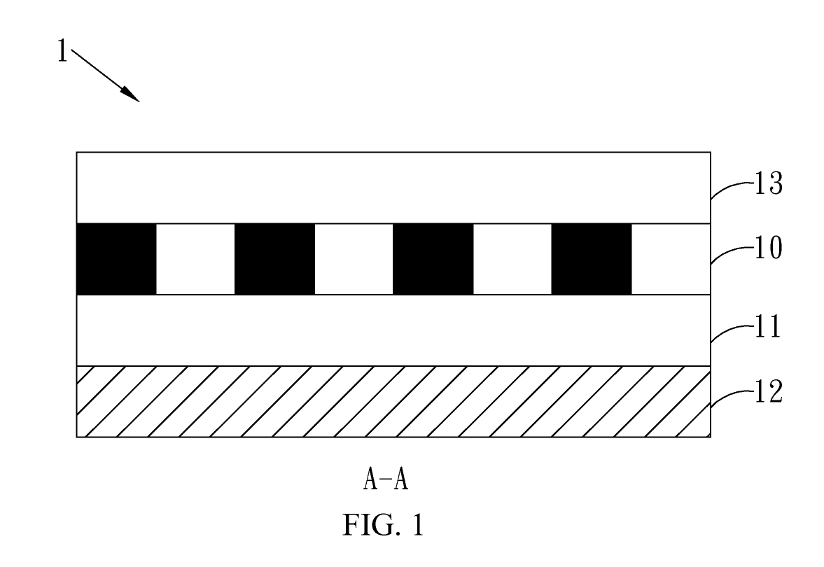

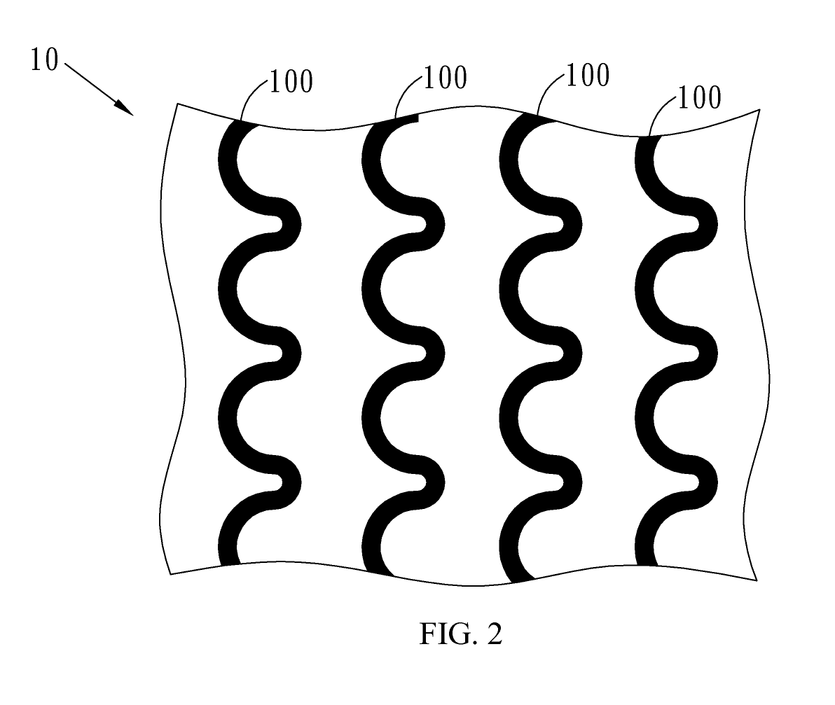

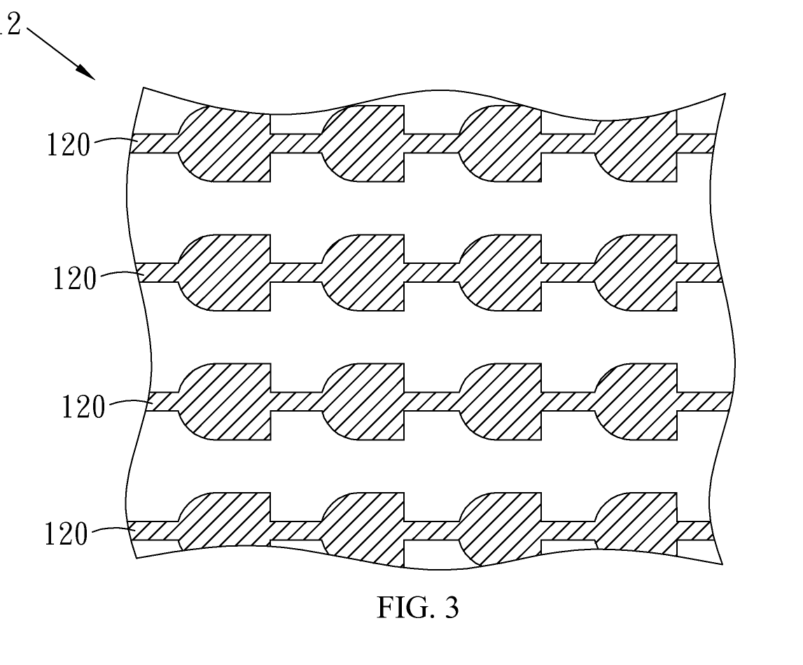

Please refer to FIG. 1, which is the sectional view of a touch capacitive panel in accordance with the present invention. As shown, the capacitive touch panel 1 comprises a first electrode layer 10, a dielectric layer 11, a second electrode layer 12, and a protective layer 13. Besides, the first electrode layer 10 comprises a first pattern 100 (as shown in FIG. 2), the dielectric layer 11 is disposed under the first electrode layer 10, and the second electrode layer 12 is disposed under the dielectric layer 11 and comprises a second pattern 120 (as shown in FIG. 3). Moreover, the second pattern 120 is complementary to the first pattern 100, each pattern is in the form of rows or columns, and each row and each column are continuous. The protective layer is disposed on the first electrode layer 10 and separates the first electrode layer 10 from outer environment to protect and achieve the scratch free goal.

The dielectric layer 11 between the upper and lower electrodes is subject to form a capacitor thereon. Moreover, the first electrode layer, the second electrode layer, the dielectric layer, and the protective layer are transparent. Furthermore, the first electrode layer and the second electrode layer are made of indium tin oxide (ITO).

On the other hand, the sequence of the layers in accordance with the present invention may be counted from the bottom as: the first electrode layer 10, the dielectric layer 11, the second electrode layer 12, and the protective layer 13.

Please refer to FIG. 2 and FIG. 3, which are the schematic view of the first and the second electrode layer in accordance with the present invention respectively. As shown in FIG. 2, the first electrode layer 10 comprises a first pattern 100; each column therein consisting of a plurality of continuous semicircle arcs, and the arcs are suitable for the finger touching shape. Referring to FIG. 3 for the second pattern 120 in the second electrode layer 12. Each row of the second pattern 120 comprises a plurality of serially connecting bullet shapes. In addition, the first electrode and the second electrode are complementary, so the sensitivity of the detection can be optimized. Besides, because the first electrode and the second electrode are not shielded, the sensitivity of the capacitor detection between the rows or between the columns can be optimized.

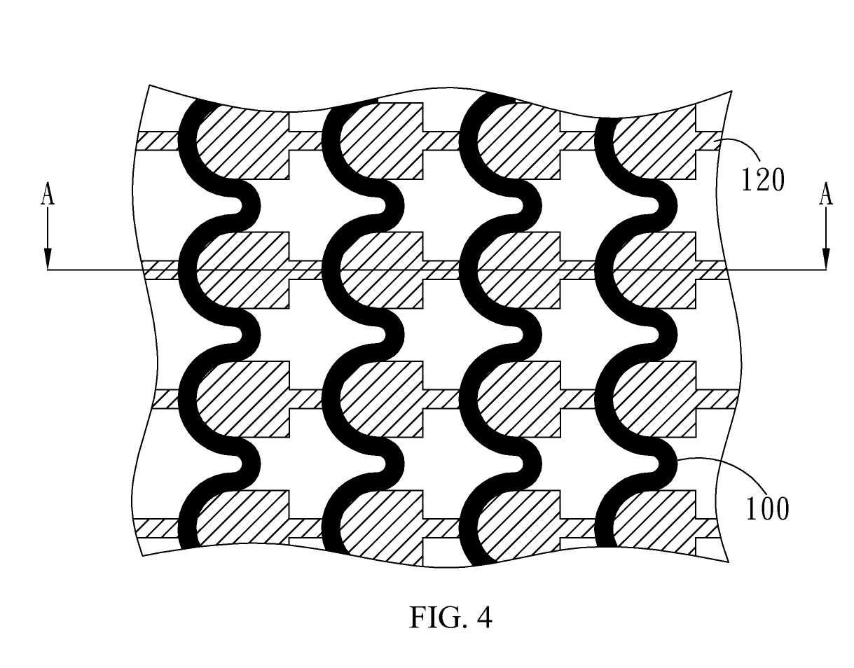

Please refer to FIG. 4, which is the schematic view of the first embodiment in accordance with the present invention. As shown, the pattern in the rows of the lower electrode layer (the second pattern 120) is not completely shielded by the pattern in the columns of the upper electrode layer (the first pattern 100), the lower electrode layer thus can process the row detection without influence of the upper electrode layer. Besides, the sectional view of the AA line is shown in FIG. 1.

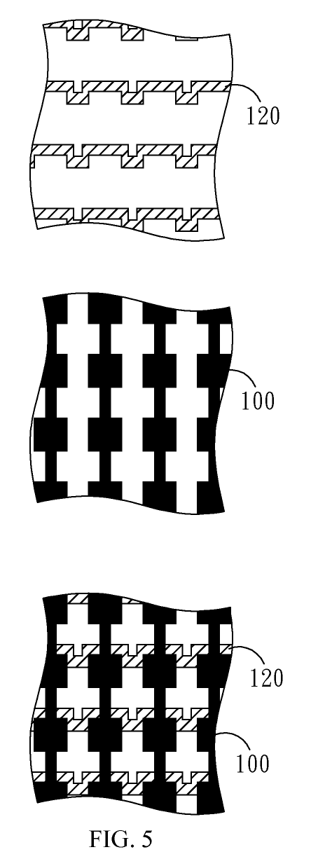

Please refer to FIG. 5, which is the schematic view of the second embodiment in accordance with the present invention. As shown, the difference between the second embodiment and the first embodiment is that the first pattern 100 is a plurality of rectangles bridging each other, and the second pattern 120 is a plurality of S shapes connecting to each other.

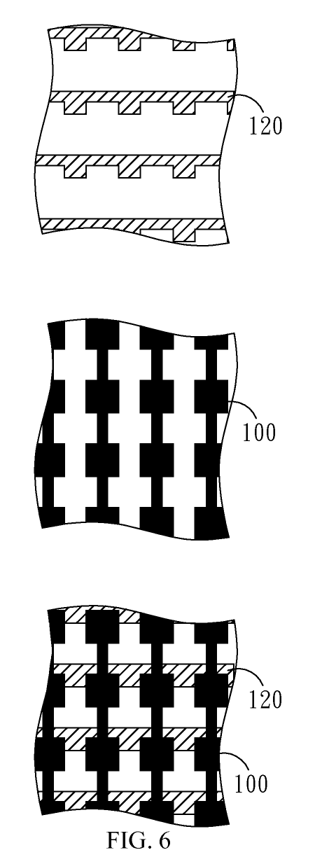

Please refer to FIG. 6, which is the schematic view of the third embodiment in accordance with the present invention. As shown, the difference between the third embodiment and the first embodiment is that the first pattern 100 is a plurality of rectangles bridging each other, the second pattern 120 is formed as grooves, and a portion of each of the rectangles in the first pattern 100 is surrounded by the second pattern 120.

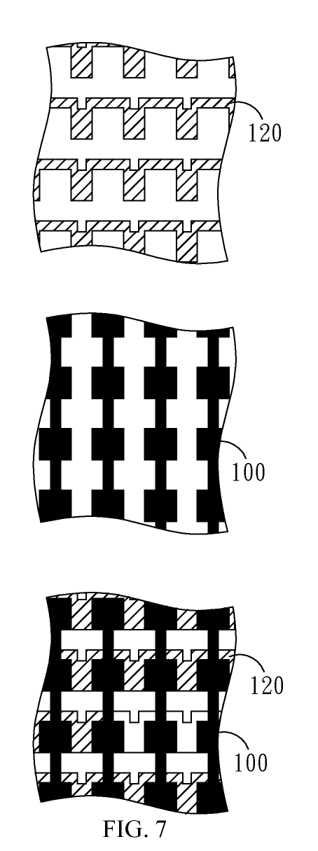

Please refer to FIG. 7, which is the schematic view of the fourth embodiment in accordance with the present invention. As shown, the difference between the fourth embodiment and the first embodiment is that the first pattern 100 is a plurality of rectangles bridging each other, and the second pattern 120 is a plurality of M shapes connecting to each other.

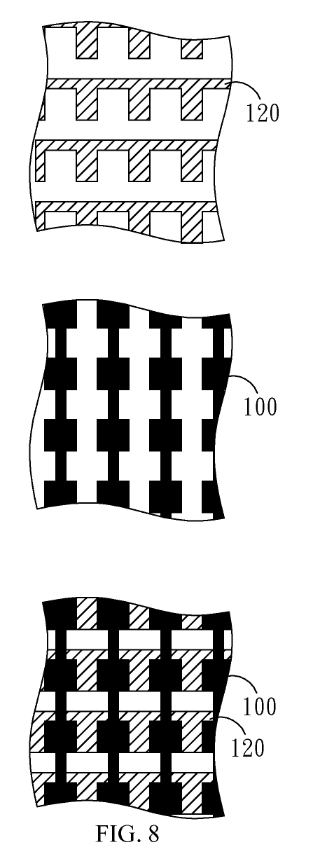

Please refer to FIG. 8, which is the schematic view of the fifth embodiment in accordance with the present invention. As shown, the difference between the fifth embodiment and the first embodiment is that the first pattern 100 is a plurality of rectangles bridging each other, the second pattern 120 is formed as grooves, and each of the rectangles in the first pattern 100 is completely surrounded by the second pattern 120.

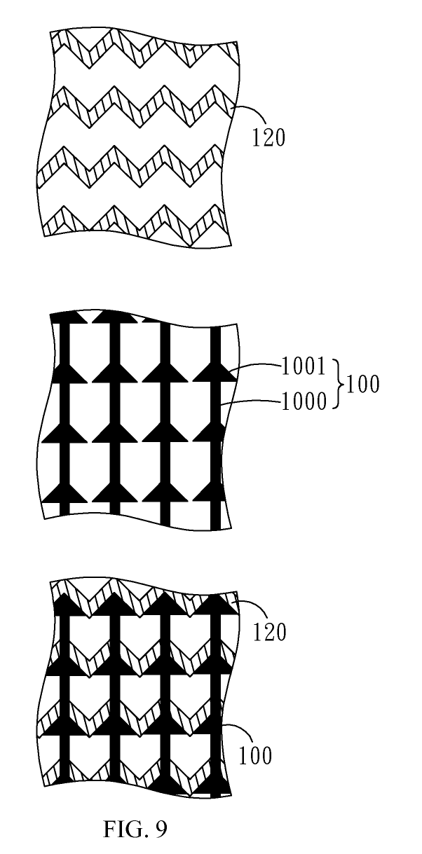

Please refer to FIG. 9, which is the schematic view of the sixth embodiment in accordance with the present invention. As shown, the difference between the sixth embodiment and the first embodiment is that the first pattern 100 is a plurality of arrow shapes comprising arrowhead portion 1000 and shaft portion 1001, the second pattern 120 is a plurality of Z shapes, and concave portions of the second pattern 120 completely surround the arrowhead portion 1000 of the first pattern 100.

The capacitive touch panel utilizes the capacitor and electrode design patterns that are different from the prior art, and the structure and control rule can achieve the goal of consumption extreme low power.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. A capacitive touch panel comprising:
a first electrode layer comprising a first pattern;
a dielectric layer disposed under the first electrode layer; and
a second electrode layer disposed under the dielectric layer and comprising a second pattern, the second pattern being complementary to the first pattern.

2. The capacitive touch panel touch panel as recited claim 1, wherein the first pattern comprises a plurality of semicircle arcs.

3. The capacitive touch panel touch panel as recited claim 2, wherein the second pattern comprises a plurality of bullet shapes.

4. The capacitive touch panel touch panel as recited claim 1, wherein the first pattern comprises a plurality of rectangles bridging each other.

5. The capacitive touch panel touch panel as recited claim 4, wherein the second pattern comprises a plurality of S shapes connecting to each other.

6. The capacitive touch panel touch panel as recited claim 4, wherein the second pattern is formed as grooves and a portion of each of the plurality of rectangles is surrounded by the second pattern.

7. The capacitive touch panel touch panel as recited claim 4, wherein the second pattern comprises a plurality of M shapes connecting to each other.

8. The capacitive touch panel touch panel as recited claim 4, wherein the second pattern is formed as grooves and each of the plurality of rectangles is completely surrounded by the second pattern.

9. The capacitive touch panel touch panel as recited claim 1, wherein the first pattern comprises a plurality of arrow shapes each comprising arrowhead portion and shaft portion.

10. The capacitive touch panel touch panel as recited claim 9, wherein the second pattern comprises a plurality of Z shapes and a concave portion of the second pattern completely surrounds the arrowhead portion of the first pattern.

11. The capacitive touch panel touch panel as recited claim 1, further comprising a protective layer disposed on the first electrode layer.

12. The capacitive touch panel touch panel as recited claim 11, wherein the first electrode layer, the second electrode layer, the dielectric layer, and the protective layer are transparent.

13. The capacitive touch panel touch panel as recited claim 12, wherein the first electrode layer and the second electrode layer are made of indium tin oxide (ITO).

14. A capacitive touch panel comprising:
a first electrode layer comprising a first pattern;
a dielectric layer disposed on the first electrode layer; and
a second electrode layer disposed on the dielectric layer and comprising a second pattern, the second pattern being complementary to the first pattern.

15. The capacitive touch panel touch panel as recited claim 14, wherein the first pattern comprises a plurality of semicircle arcs.

16. The capacitive touch panel touch panel as recited claim 15, wherein the second pattern comprises a plurality of bullet shapes.

17. The capacitive touch panel touch panel as recited claim 14, wherein the first pattern comprises a plurality of rectangles bridging each other.

18. The capacitive touch panel touch panel as recited claim 17, wherein the second pattern comprises a plurality of S shapes connecting to each other.

19. The capacitive touch panel touch panel as recited claim 17, wherein the second pattern is formed as grooves and a portion of each of the plurality of rectangles is surrounded by the second pattern.

20. The capacitive touch panel touch panel as recited claim 17, wherein the second pattern comprises a plurality of M shapes connecting to each other.

21. The capacitive touch panel touch panel as recited claim 17, wherein the second pattern is formed as grooves and each of the plurality of rectangles is completely surrounded by the second pattern.

22. The capacitive touch panel touch panel as recited claim 14, wherein the first pattern comprises a plurality of arrow shapes comprising arrowhead portion and shaft portion.

23. The capacitive touch panel touch panel as recited claim 22, wherein the second pattern is a plurality of Z shapes, and a concave portion of the second pattern completely surrounds the arrowhead portion of the first pattern.

24. The capacitive touch panel touch panel as recited claim 14, further comprising a protective layer disposed on the first electrode layer.

25. The capacitive touch panel touch panel as recited claim 24, wherein the first electrode layer, the second electrode layer, the dielectric layer, and the protective layer are transparent.

26. The capacitive touch panel touch panel as recited claim 25, wherein the first electrode layer and the second electrode layer are made of indium tin oxide (ITO).
